(19) United States
(12) Patent Application Publication
(10) Pub. No.: US 2002/0133964 A1
(43) Pub. Date: Sep. 26, 2002

(54) Magnetic length measuring device

(75) Inventors: Klaus-Manfred Steinich, Poering-Zorneding (DE); Peter Wirth, Eching (DE)

Correspondence Address: HEAD, JOHNSON & KACHIGIAN, 228 W 17TH PLACE, TULSA, OK, 74119, US

(73) Assignee: ASM Automation Sensorik Messtechnik GmbH

(21) Appl. No.: 10/073,721

(22) Filed: Feb. 11, 2002

(30) Foreign Application Priority Data
Feb. 13, 2001 (DE) 101 06 478.0
Jan. 10, 2002 (DE) 202 00 330.2

(51) Int. Cl. G01B 7/00

(52) U.S. Cl. 33/708

(57) ABSTRACT

Magnetic length measuring devices must be simple and inexpensive to produce, in particular in respect of the sensor head, and in a simple and inexpensive manner must permit assembly of the measuring scale in well-protected form. In accordance with the invention that is achieved by the specific form of housing and manner of assembly of the sensor head on the one hand and the structural shape and manner of fixing of the profile bar on the other hand.

### FIELD OF USE

The invention concerns a measuring device which includes a head which contains a sensor unit. A typical case of such a measuring device is a length measuring device.

### TECHNICAL BACKGROUND

Arranged on the periphery of a cylinder, such a length measuring device can naturally basically also be used for angle measurement.

The length measuring device includes on the one hand a measuring scale on which the length units are recorded and a sensor unit which is moved in the measuring direction relative to the measuring scale. In general, that arrangement records how many length units are covered in that relative movement on the part of the sensor unit, that is to say, how many length units the sensor unit entirely or partially travels over. The absolute position at the end of the relative movement can only be calculated if the starting position prior to the relative movement is known.

For that purpose, the straight or curved measuring scale only has in a single track or in a plurality of tracks in mutually juxtaposed relationship, in succession in the measuring direction, respective codings, in most cases regular and periodic codings, with the pitch spacing being different from one track to another. In addition, provided along the measuring section, in general mostly only at a single lengthwise position, is a reference mark, the position of which represents the absolute zero position and which therefore, for the device to be set in operation, firstly has to be travelled over once in order to predetermine an absolute start value.

In addition however length measuring devices which measure in absolute terms are also known. In that case, by virtue of the design of the measuring scale divisions and the evaluation process involved, for example by only once setting the sensor to a desired location on the measuring scale, it is possible to directly ascertain the absolute position of the sensor on the measuring scale, without relative displacement of the sensor with respect to the measuring scale and without initially having to move to a reference point on the measuring scale.

Irrespective of whether the device involves an incremental or an absolute length measuring system, the measuring device according to the invention includes one or more or a multiplicity of magnets which provide for modulation of the signal to be detected. For example, the individual length units are disposed on the measuring scale in succession in the measuring direction, in the form of different magnets or magnetisation effects, for example in the form of segments of alternate polarity which are each of the same length in the measuring direction.

The sensor unit which is moved relative thereto in the measuring direction and which, besides the actual sensor, generally already includes at least parts of the electronic evaluation system, detects the magnetic field which changes continuously in the measuring direction, in the form of an analog signal, as a sinusoidal oscillation or a sine-like but regular oscillation. A major advantage of this method is the fact that the sensor can be guided at a spacing, that is to say in a contact-less manner, relative to the measuring scale. The measuring scale and also the sensor are thus not subjected to any mechanical wear. In addition parallelism in terms of guidance of the sensor relative to the direction of travel of the measuring scale only has to be limitedly implemented. In particular the spacing between the sensor and the measuring scale, which should be about 1.0 mm, may also alter somewhat.

The electronic system for evaluation of the measurement signals includes on the one hand a converter for converting the periodic analog signal, for example a sinusoidal oscillation, into a periodic digital signal, for example a rectangular signal.

In that respect a sinusoidal signal does not necessarily have to correspond to a rectangular signal; as the form of the analog signal is known, the relative position in the measuring direction can be ascertained within a period of the analog signal by relatively accurate evaluation of the analog signal, for example the instantaneous absolute value. An interpolator, generally in the form of an electronic circuit, for example on the basis of the previously described methods, provides that the for example periodic digital signal obtained does not have smaller pitch spacings than the for example periodic analog output signal, that is to say the level of resolution of the digital signal is substantially higher. In that respect, the factor of the higher level of resolution can be adjusted at the interpolator and, if the interpolator is in the form of a programmable circuit, can be adjusted by means of re-programming or a change in programming.

In general in that respect the converter is integrated in the interpolator in terms of circuitry and/or physically.

Likewise further parameters, for example correction factors for correction of the characteristics of the electronic system, correction factors for adjusting the zero point and/or gain of the electronic system or individual structural groups of the electronic system, correction factors for adjusting the position of the reference point within a pitch of the measuring scale can also be adjusted at the interpolator and in particular reprogrammed.

The electronic system also includes a line driver circuit which as usual serves to improve the transmission capability of the output signal, for example by reducing the impedances.

The electronic system further includes a protective circuit which protects the entire electronic system or at least parts thereof from excessively high voltages and/or excessively high currents, as can occur for example by virtue of incorrect polarity at the output unit.

In general the electronic system, at its peripheral connections to the environment, in the conductor tracks, has internal node points which are connected to the electronic components of the electronic system, and external node points which are connected to the connecting cable of the output unit, the power supply and all further contact points which are accessible from the exterior, for example of the contacting unit, for programming the interpolator.

In that case the protective circuit is between the internal and external node points and in the present case can certainly be a structural component of the interpolator and/or the line driver circuit.

The protective circuit provides for limiting the electrical currents in the conductors to and from the electronic system and provides for carrying away excessively high voltages in those conductors, for example by virtue of using current-limiting impedances (ohmic resistors or frequency-dependently absorptive by ferrite chokes, frequency-dependently reflective due to inductances or current-dependent due to PTC-resistors or integrated as current-dependent limitation means in the output stage of the power driver) and/or voltage-limiting components (for example captiodes, in particular integrated in the line driver, by-pass diodes, varistors).

The electronic system further includes an output unit in order to be able to output that digital and generally high-resolution signal, either to a display unit, for example a digital display, or for further processing to a machine control.

In general, for that purpose, fixedly arranged on the sensor unit is a cable, at the end of which is arranged a plug as the output unit.

So that such a measuring device can be used with maximum versatility on widely differing machines and installations, besides the highest possible level of insensitivity in relation to physical and chemical influencing factors, a further aim is to provide for the smallest possible structural dimensioning both of the measuring scale and also the sensor unit.

In that respect the measuring scale generally comprises a magnetic band of a thickness of between 1 and 2 mm and about 1 cm in width, which is flexible and which is glued by means of a self-adhesive coating or a double adhesive band directly on a machine but also on a profile bar which permits sufficient flatness, and is covered as mechanical protection by a high-quality steel plate which is non-magnetisable.

The important consideration in regard to the sensor unit is in particular a small structural height. More especially the sensor unit should not be wider than the measuring scale. The sensor unit should also not project in the measuring direction unlimitedly beyond the position of the actual sensor which is generally very short in the measuring direction and only a few millimeters long, as such a projection configuration in fact requires the measuring scale to be overlength over the distance to be measured.

In contrast the extent of the sensor unit in a direction perpendicularly to the plane of the measuring scale is less critical.

In that respect it is usual for the parts arranged in the movable sensor unit, in particular the parts arranged therein of the electronic system, to be protected by a surrounding fixed housing and/or by being embedded in plastic material.

If the factor by which the digital signal had a higher level of resolution than the basic analog signal, that is to say the pitch division of the measuring scale, should be subsequently adjustable, for example by means of programming, which is necessary in particular when using one and the same length measuring device for different purposes of use, the corresponding interpolator was hitherto not disposed within the movable sensor unit, but arranged as a separate structural group remote from the sensor unit, so that the signals obtained by the sensor unit were converted by means of cable and plug in that separate interpolator.

III. Statement of the Invention

a) Technical Object

Taking that situation as its basis, the object in accordance with the invention is that of providing a measuring device which is small and compact and nonetheless operationally reliable and in which in particular the head with the sensor unit is to be very robust.

b) Attainment of the Object

That object is attained by the features of claims 1 and 11 through 15. Advantageous embodiments are set forth in the appendant claims.

By virtue of closure of the measuring side, that is to say for example the front face, which is towards the measuring scale, of the head with the sensor unit, by a front plate, the sensor unit is substantially less sensitive in relation to environmental influences. Even if the interior of the sensor unit, that is to say the electronic system disposed therein, is protected by filling up the interior of the sensor unit with plastic material, the resulting front face of plastic material is still relatively sensitive. Admittedly, in normal operation the sensor unit and therewith also that front face do not touch the measuring scale, but mechanical contact can occur in the event of the measuring scale making unwanted contact, in particular also if contamination passes between the sensor unit and the measuring scale, for example metal chips from the cutting machining operation if the length measuring device is used on a machine tool. By virtue of such influences, a hard piece can penetrate into the relatively soft plastic material of the front face and cause damage there, which can be avoided by a front plate of substantially greater hardness.

For that purpose, it is sufficient under some circumstances for that front plate which generally comprises metal but non-magnetic metal such as for example high-quality steel (steel alloys with a high nickel and/or chromium proportion, in particular greater than 10% by weight), aluminum or titanium, to be relatively thin.

Preferably such a front plate is fitted flush on to the front face of the rest of the body of the sensor unit and the body of the sensor unit is thereby sealingly closed.

As this is preferably effected before the operation of teeming the electronic system in the housing of the sensor unit, it is also no longer necessary to provide separate sealing means for the teeming operation.

In a preferred embodiment—particularly when using a magnetoresitive sensor—therefore a thin metal foil of between 10 and 50 μm in thickness is fitted by welding, the available welding processes being all kinds of electron beam welding or arc welding, in particular wick, mick, mack welding, laser welding, ultrasound welding and plasma welding, wherein preferably the front plate is applied flush to the front face of the body and joined from the external peripheral surface sealingly to the rest of the body. For a welding operation, the two materials involved, that is to say the body and the front plate, do not necessarily have to consist of the same material but—when dealing with metal materials—the two metals must be alloyable with each other so that they can be welded together. In that respect, particularly in the case of electron beam welding or arc welding, there is also the possibility of introducing an additional material into the weld seam by way of the electrode as it burns away, which additional material under some circumstances first permits weldability of the materials of the body and the front plate relative to each other.

By virtue of the fact that the head of the sensor unit includes a housing which is of a uniform cross-section in at least one direction, the reduction in length of the housing in that direction does not cause any problems.

This makes it possible to produce housings which are of different lengths in that direction, for example depending on the advance in miniaturisation of the electronic arrangement to be disposed therein or also depending on the respective amount of functions and thus the physical structural size of those electronics.

In particular in the direction in which the housing is of a uniform cross-section is the perpendicular direction, that is to say that direction which extends transversely and in particular perpendicularly to the front face of the head, near to which is disposed in the head of the sensor unit the actual at least one sensor, and thus also perpendicularly to the plane of the measuring scale which is defined by the measuring direction, that is to say the longitudinal direction on the one hand and the transverse direction in relation thereto in the plane of the measuring scale on the other hand.

In particular the housing, over its entire longitudinal extent, is of such a uniform cross-section, possibly apart from openings such as for example bores or other orifices, which additionally interrupt that cross-section at some locations. At no point on the longitudinal extent however does the cross-section have projections which protrude beyond the usual cross-section so that the body of this housing can be produced with an economical process, more specifically on the one hand in the form of an extrusion from which the desired length merely has to be cut off, or also in the form of a cup-shaped housing which is produced by means of deep drawing and in which then the bottom of the cup is used as the rear of the body.

One of the open sides of the body of the housing is always used as the front side which faces towards the measuring scale, that is to say one of the open ends when the housing is manufactured from an extrusion.

The interior of the body is filled with teeming material after the electronic arrangement is disposed therein, at least over a part of the internal space, beginning from the front face, as will be described in greater detail hereinafter. In this case, a filling operation can also be effected as far as the rear side, but in general that rear side is—possibly additionally—closed by a cover. That cover itself can in turn be a portion of another extrusion, the cover profile member.

The profile cross-section of the body is preferably symmetrical with respect to the two longitudinal center lines in the measuring direction and in the transverse direction. Arranged on the inward sides of the end walls which face in and in opposite relationship to the measuring direction, that is to say the longitudinal direction, are mutually oppositely disposed board grooves, preferably two pairs of board grooves, each in adjacent relationship with a side wall, so that boards with electronic means mounted thereon can be inserted into those grooves. In particular this can be in such a way that the components equipping those boards are disposed on the side remote from the adjacent side wall of the body, that is to say the board components of two mutually oppositely disposed boards are positioned in the intermediate space between the boards and in that way can be particularly effectively protected from environmental influences and mechanical damage, in particular by subsequent teeming therein.

In addition, preferably on the longitudinal center, provided at those side walls there are once again mutually opposite screw grooves of an undercut cross-sectional configuration. In the undercut region those screw grooves are preferably of a round cross-section and serve for screwing in screws in the longitudinal direction of the grooves from the open end of the profile, for example for fixing the cover. If however the smallest free cross-section of those screw grooves corresponds at least to the thickness of the boards, that is to say for example the width of the board grooves, then a board can also be inserted into that pair of mutually oppositely disposed screw grooves and in addition—in another lengthwise region—screwing can be effected in those screw grooves.

The cover which is to be screwed in that way on to the rear of the body can be a simple flat plate which bears against the rearward face of the body profile and is screwed thereto, or the cover can engage from the rear between the side walls, which requires partial removal of the end walls of the body housing, for example by being milled away.

If the cover is made from portions of an extruded cover profile by means of cutting it to length, that cover profile preferably comprises a rear plate and a prolongation portion which projects therefrom and which also belongs to the profile cross-section and which thus extends over the entire length of the cover profile. The profile portion is used as the cover in such a way that the direction in which the cover profile extends is the transverse direction and the prolongation portion projects from the rear plate into the body.

Arranged in the prolongation portion are one or more through openings which are spaced in the longitudinal direction, the measuring direction, possibly also being in the form of a groove of undercut configuration. Positioned in relation to that one or preferably two transverse bores which are arranged symmetrically with respect to the center in the longitudinal direction, in the side walls of the body, near the rear side, are similar bores, so that after insertion of the cover it is possible to use screwing through the cover and the body as the connecting means and at the same time such screwing possibly serves to fix the sensor head to a component carrying same, in most cases a machine element whose movement is to be monitored and measured.

The through bores can be respectively arranged in a separate prolongation portion or in a common prolongation portion of suitably large dimensions. At any event the prolongation portion must be of a greater extent in the longitudinal direction than is required for those transverse bores if, in addition to the transverse bores in the cover, a fixing screwthread which is accessible from the exterior and which extends transversely with respect to the plane of the rear plate of the cover and thus on the perpendicular of the body is to be arranged there. This one or also two fixing screwthreads is preferably in the form of a blind hole screwthread and is preferably subsequently provided in the extrusion which has been cut to length.

This fixing bore permits screwing of the head of the sensor by way of the cover thereof to a supporting component. By virtue of fixing to a component carrying it, both the rear side and also the outward side of the cover and also the side walls of the body are flat on the outside.

The cable is preferably passed into the body by way of one of the end faces. For that purpose the cable passes through a cable sleeve of plastic material or other material which prevents friction of the cable against the metal body. For receiving the cable with the sleeve, one of the side walls is partially removed from the rear so that the sleeve can be pushed on to the free ends of the milled-away end wall, preferably as is known, by means of two oppositely disposed, outwardly open grooves.

Instead of conventionally pushing the cable sleeve over the cable and then only pushing the cable sleeve—generally after fixing the free ends of the wires of the cable to the circuit boards of the electronic system—into the opening in the body for the sleeve, the sleeve can also be injection molded on the cable at the appropriate position thereon using a thermoplastic material, in particular a hot melt adhesive, by positioning the cable in a suitable mold and injection molding the cable sleeve directly on to the cable.

In the same manner the cable sleeve can be joined to the cover by way of an elastic hinge so that the cover cannot be lost, after the cover screw means are released. In particular the cover itself can be produced together with the cable sleeve as a one-piece plastic component and as described above also produced by injection molding on the cable directly at the appropriate position thereon.

If the cover does not have any transverse bores, a respective transverse sleeve can be pushed through each of the transverse bores in the side walls, the transverse sleeves serving to pass through a screw means but at the same time sealing off the interior of the sensor housing with respect to the ambient atmosphere. The transverse sleeves can be screwed, glued or clamped in the transverse bores in the body.

Closure of the rear side of the body by means of a cover, in particular a removable cover which is therefore fixed by screw means or latching or clamping, is appropriate in order to be able to gain access to the interior of the head of the sensor unit by removal of the cover. There, the electronic system—generally including the actual sensors—is disposed on one or generally two rigid boards. They are pushed into the board grooves in the body and extend to close to or directly at the front face of the sensor body and then material is teemed therearound to such an extent that the rearward internal space of the body, which is adjacent to the rear side, still remains free, and therefrom there is still access to the contact points of a contacting unit, generally formed from the rearwardly extending prolongation portion of one of the boards, and the electronic system can be programmed by applying a programming unit to those contact points, in particular it can be programmed in regard to programmable parameters such as resolution, characteristic correction of the magnetic characteristics of the periodic analog signal, zero point correction and gain correction, and position of the reference mark within a measuring scale period, that is to say a segment. If that rear free space, which remains after the first filling operation, with the contact points for the contacting unit is also filled after the programming operation, a cover which can be fitted in position and removed, on the rear of the body, is not absolutely necessary and it is possible to make a saving in respect thereof, to the benefit of filling with appropriate material as far as the rear side, also including the contacting unit.

A contribution to further reducing the size of the sensor head is afforded if as many as possible of the electronic components on the board or boards, which are there used in the form of integrated circuits, that is to say in the form of a chip, are fixed in the form of a non-housed bare chip on the board and are then secured by means of a teeming or casting operation. As the non-housed bare structure requires less than 1/10th and in part less than 1/20th of the base area and the volume of a housed chip, the use of non-housed chips in particular for the generally at least two sensors as well as the converter and the interpolator reduces the structural size of the electronic system to such an extent that, in comparison with the use of housed chips, the extent of the body housing in the direction of extension thereof, that is to say perpendicularly to the end face, can be reduced again by half in comparison with the use of housed chips, and then under some circumstances is less than 2 cm and thus in particular less than double the width of the measuring scale.

It is precisely when teeming material around an electronic system with non-housed chips but also when using housed chips, that care is to be taken to ensure that the components of the electronic system are completely enclosed by the teeming material, generally an epoxy resin which contains in particular 70%-80% of finely ground quartz. The reference to completely is intended to mean that, because of the electrically conductive connection of those components with respect to the conductor tracks of the board, 100% enclosure is never possible as the enclosure around the individual component by teeming material must be penetrated by that electrically conductive connection to the exterior, that is to say towards the board.

One possibility also involves teeming material around the electronic system and in that case using the outside surfaces of the hardened teemed material at the same time as the outside surface of the head so that therefore the teeming operation is not effected in a housing which is a component part of the head but in a removable and re-usable mold.

In regard to the dimensioning of the head of the sensor unit the width of the head should be no greater than 1.5 times the width of the measuring scale and in particular no wider than the measuring scale and in particular less wide than the measuring scale.

In contrast the extent of the head in the longitudinal direction, the measuring direction, can be greater but in particular no greater than 70 times and in particular no greater than 50 times the extent of one of the differently magnetised segments of the measuring scale.

The extent of the head in the perpendicular should preferably be less than the extent in the measuring direction as increasing extents in the perpendicular require increasing free space, more particularly over the entire length of the measuring device, in particular the measuring scale.

The procedure involved in manufacture of the head of the sensor unit, which results in simple and thus inexpensive manufacture, thus consists of the following steps:

a) Electrically conductively connecting the wires of the cable leading away from the head to the contact points of the circuit on the boards of the electronic system, wherein that connecting operation is preferably effected before introduction of the boards and also the wires into the end position of the head,

b) arranging the cable sleeve on the cable, that is to say pushing a prefabricated sleeve thereover or injection molding a sleeve on the cable sheath at the outside periphery thereof,

c) inserting the board into the grooves, in particular the board grooves and/or the screw grooves, of the body profile and inserting the cable sleeve with the cable from the rear of the body into the corresponding cable sleeve opening, in which case preferably both are effected together from the rear,

d) sealingly placing the body with its flat front face on a flat sealing underlying support and then filling the interior of the body to such a height that the fixed boards including the flexible board connecting them are completely covered by the teeming material and only the contacting unit, that is to say the contact points on the prolongation portion which projects beyond the rest of the edge of the boards, of one of the boards, are still accessible for later programming,

e) after hardening lifting the body from the sealing support.

An alternative procedure involves:

f) Electrically conductively connecting the wires of the cable leading away from the head to the contact points of the circuit on the boards of the electronic system, wherein that connecting operation is preferably effected before introduction of the boards and also the wires into the end position of the head,

g) arranging the cable sleeve on the cable, that is to say pushing a prefabricated sleeve thereover or injection molding a sleeve on the cable sheath at the outside periphery thereof,

c) sealingly connecting, in particular welding, in particular by means of laser, the front plate to the front end of the body profile,

d) inserting the board into the grooves, in particular the board grooves and/or the screw grooves, of the body profile and inserting the cable sleeve with the cable from the rear of the body into the corresponding cable sleeve opening, in which case preferably both are effected together from the rear,

e) filling the interior of the body to such a height that the fixed boards including the flexible board connecting them are completely covered by the teeming material and only the contacting unit, that is to say the contact points on the prolongation portion which projects beyond the rest of the edge of the boards, of one of the boards, are still accessible for later programming.

Then either the (removable) cover can be fitted on to the rear of the body and later removed again for programming. Another possibility involves holding the sensor on mountings in that open mold and, only when the situation of use is known, implementing definitive programming by connecting a programming unit to the contacting unit in the interior of the body, and then also completely filling the remaining free space in the rearward part of the body.

Optionally before beginning the assembly procedure the body has to be shortened or cut to the desired dimension in respect of its longitudinal extent, in particular in the perpendicular, that is to say in the direction in which the body profile extends. If milled-out openings are already provided at the rear, for example for receiving the cover or the cable sleeve, the corresponding reduction in length must be effected from the front face.

In operation of the measuring device the head of the sensor unit is moved in the longitudinal direction along the measuring scale with a small air gap, that is to say in a contact-less mode. In that respect, the spacing, that is to say the air gap, is not to exceed a maximum value and also the lateral deviation may only be to such an extent that the respective sensor of the sensor unit is still within the width of that track of the measuring scale which it is intended to sense.

The measuring scale itself comprises a generally limited flexible strip which is about 1 mm thick and 1 cm wide and which at least partially comprises the differently magnetised segments. That magnetic strip can be protected on the top side by a cover means, for example of high-quality steel plate, or other non-magnetisable material.

The measuring scale 1 can be mounted directly on a machine or the like by means of adhesive using a double-sided adhesive band. If the support available for that purpose is not sufficiently flat the adhesive effect can be completed by means of a compensating adhesive layer, for example a double-adhesive strip on a foam base, being between about 0.5 mm and 1 mm in thickness, or a pasty adhesive layer of corresponding thickness.

In addition the measuring scale can firstly be fixed by adhesive on a profile bar and that profile bar which in itself is rigid and torsionally stiff can only then be fixed on the component which actually carries it, such as for example a part of a machine.

The corresponding profile bar is preferably again produced in the form of an inexpensive extrusion, for example of aluminum.

The profile shape of that profile bar is preferably symmetrical with respect to the longitudinal center and has a central base surface on which the measuring scale is mounted, in particular by adhesive. That base surface which is of optimum flatness is not or is only scarcely wider than the measuring scale itself and on both sides has raised portions, the height of which is equal to or higher than the thickness of the measuring scale. Preferably the upper ends of the raised portion are positioned slightly higher than the top side of the measuring scale so that a sensor head which is carried on the measuring scale for any reasons, instead of being supported on the measuring scale, only fits on the raised portions, so that it is possible to omit an additional cover means comprising high-quality steel sheet.

In addition projections project from the lateral outside in a direction towards the longitudinal center of the profile bar, but terminate outside the width region of the raised portions and also above the maximum height thereof and serve for laterally guiding the sensor head.

In general, in that case, the head of the sensor unit is guided by means of the component carrying it of the machine to be monitored, just above the measuring scale and in particular between the mutually facing projections, in which case the profile shape of the profile bar and in particular the projections thereof do not serve to guide the head but only to provide for coarse positioning thereof.

If fine positioning by means of the profile bar is wanted, the sensor unit is fixed on a carriage or slide which is guided in positively locking relationship on the profile bar in the longitudinal direction and which is positioned by same in positively locking relationship in all other directions.

Preferably such a slide comprises a lower part and an upper part which are screwed together, wherein only the lower part is guided in positively locking relationship by the profile bar.

In that case the lower part is either guided in the guide grooves which are formed between the projection and the raised portion at each side, or in a separate guide groove which is formed by virtue of the fact that the ends of the projections, which project freely inwardly from the side, are of a forked configuration, with a guide groove which is shaped therebetween and which faces towards the center.

At its underside the profile bar preferably has two line-shaped or strip-shaped flat underneath faces with which it is placed on and fixed to the support. For that purpose the profile bar laterally outwardly comprises an upwardly directed shoulder for fitting holding clips. It can go into a perpendicular shoulder which then serves for lateral contact and thus positioning in the transverse direction of the profile bar.

That can be advantageous if a plurality of portions of a profile bar, for the purposes of affording an increase in length, have to be fitted together in succession in the measuring direction and have to be arranged in alignment:

Preferably the profile of the profile bar, in particular on both sides and in particular lower than the base surface, has grooves which are open upwardly, in particular into the intermediate space between the prolongation portions and the raised portions and which in particular are of an undercut configuration in the form of screw grooves and serve for insertion at the end of fitting pins for attaching an adjacent profile bar. Equally however the lateral, upwardly and outwardly directed shoulders can also serve for aligned orientation of two mutually adjoining profile bars.

Otherwise the upwardly directed shoulders serve for fitting holding clips which are screwed outside the region of the profile bars at any location with respect to the support or a load-bearing element and which with a freely ending limb press from above against the shoulder and thereby hold the profile bar in firm force-locking relationship on the support.

Instead of fitting individual clips from both sides, it is also possible to use a single U-shaped holding clip which extends under the profile of the bar with the connecting limb, but this requires the presence of fixing bores on the receiving component at the same longitudinal position on both sides of the profile bar. The holding clips permit the profile bar to be very quickly changed for another, higher or flatter, profile bar or a completely different measuring scale.

c) Embodiments

Embodiments of the invention are described in greater detail hereinafter. In the drawing:

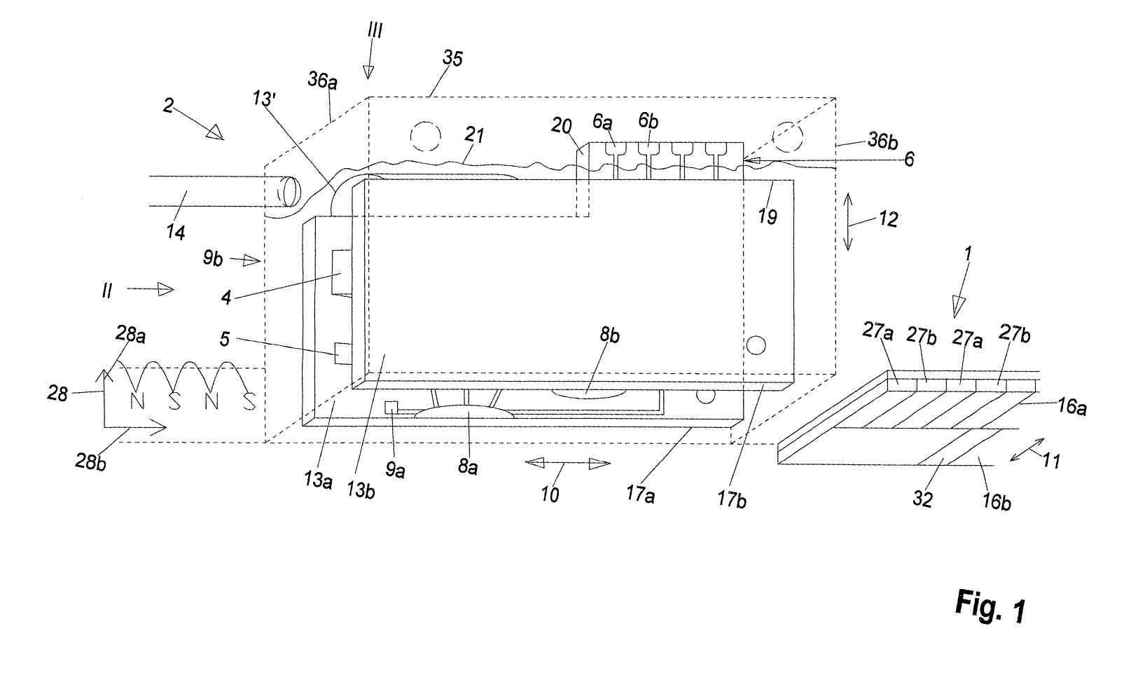

FIG. 1 is a perspective view showing the principle of a sensor unit and a measuring scale,

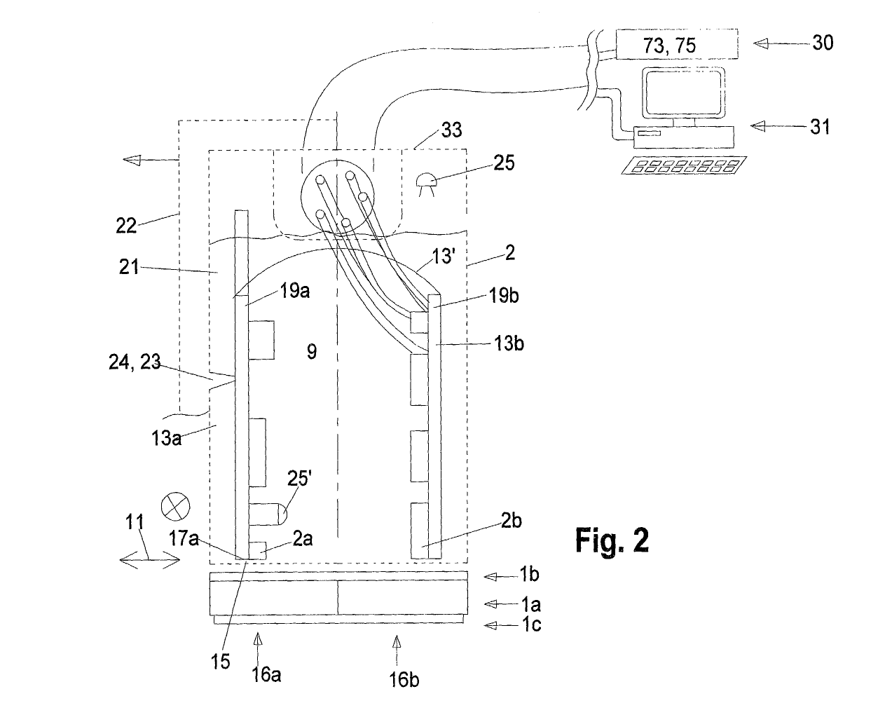

FIG. 2 is a view of the arrangement of FIG. 1 looking in the direction II,

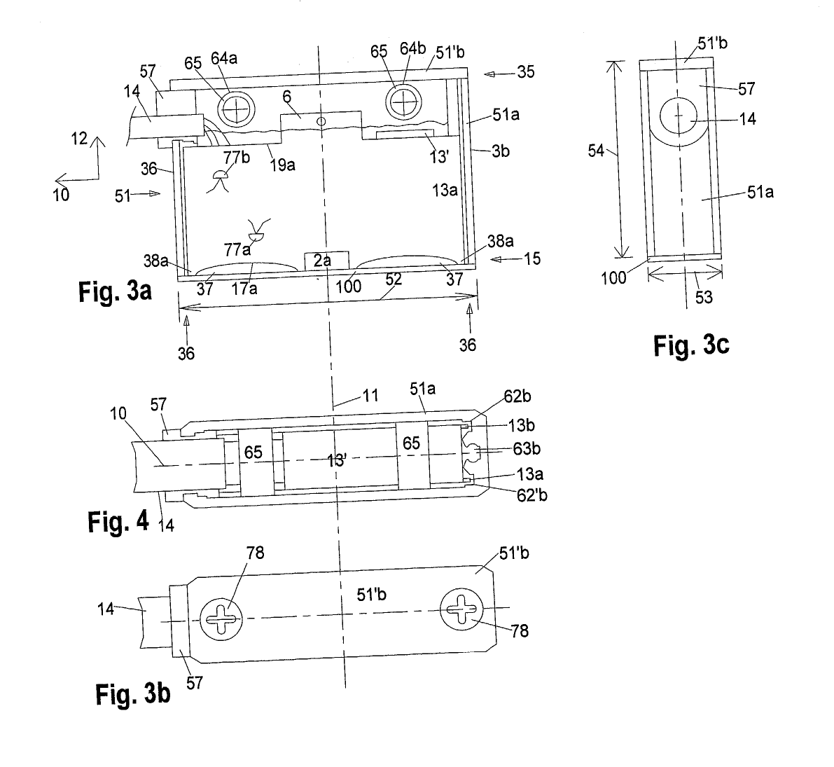

FIG. 3a is a view in longitudinal section through a head of the sensor unit,

FIG. 3b is a plan view on to the head shown in FIG. 3a,

FIG. 3c is an end view of the head shown in FIG. 3a,

FIG. 4 is a partial cross-section through the head of FIG. 3a,

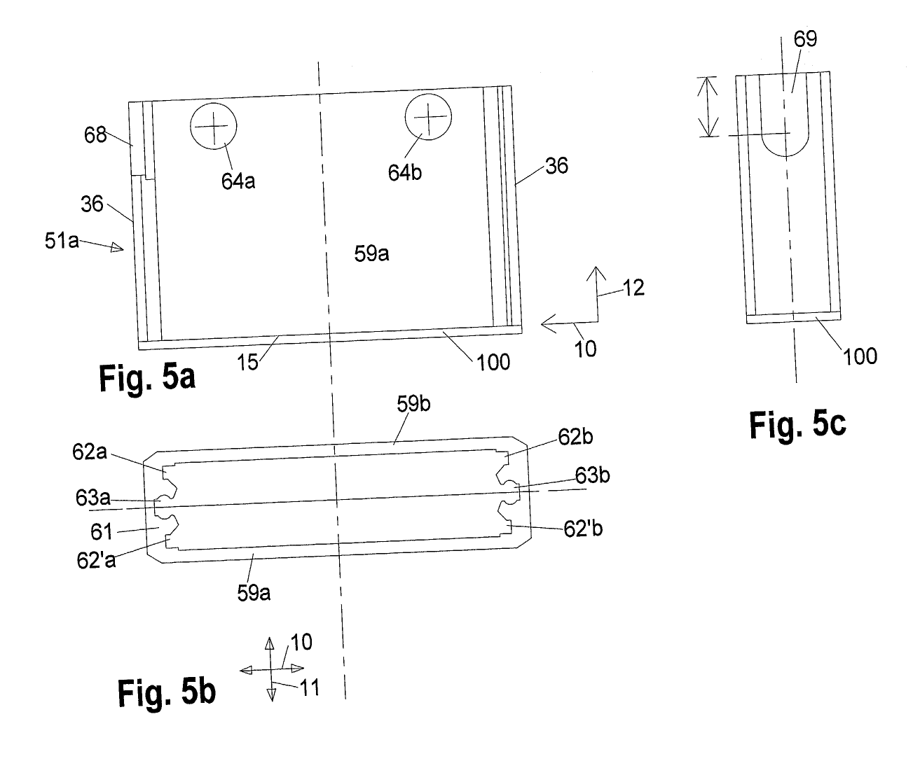

FIG. 5 shows views of the finished machined body,

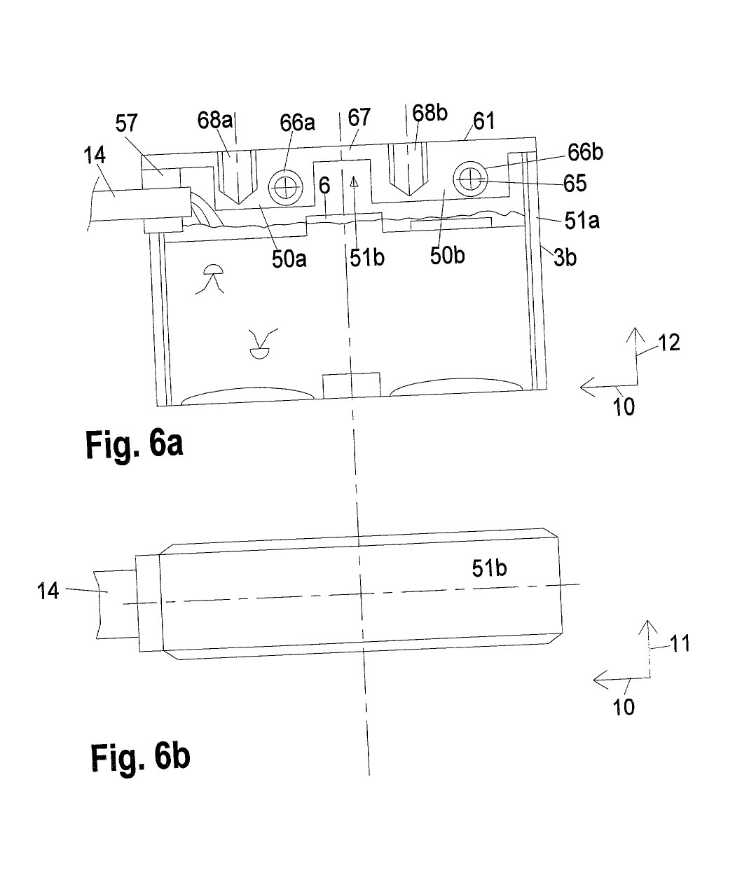

FIG. 6a shows a longitudinal section through another embodiment of the head similarly to FIG. 3a,

FIG. 6b shows a plan view on to the head of FIG. 6a,

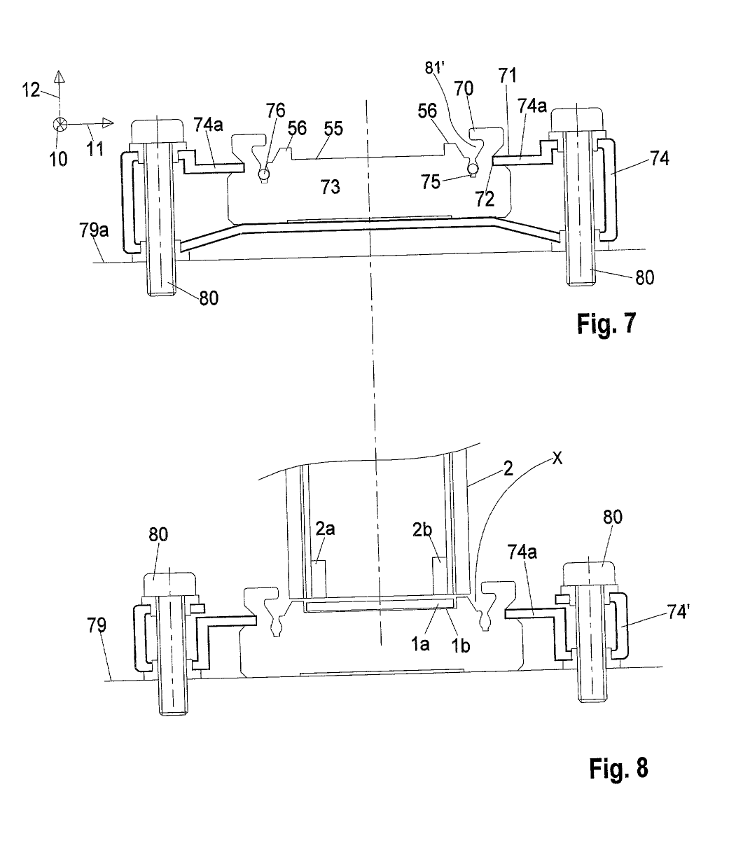

FIG. 7 shows a profile bar for the measuring scale, screwed in relation to the support,

FIG. 8 shows the same profile bar, but screwed with different clips on the support,

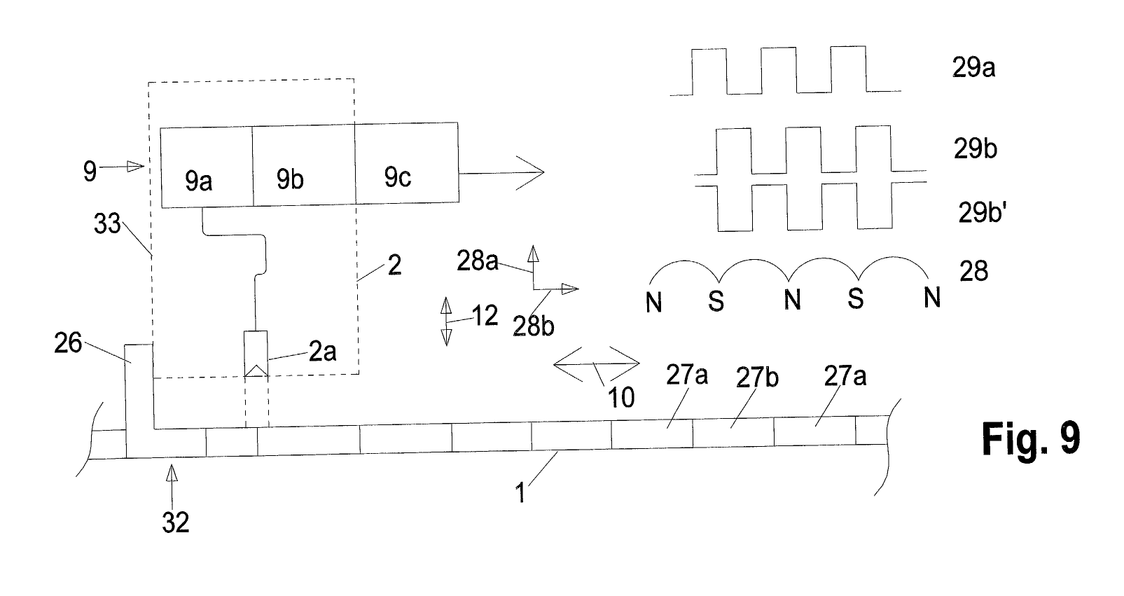

FIG. 9 is a diagrammatic view showing the components of the measuring device, and

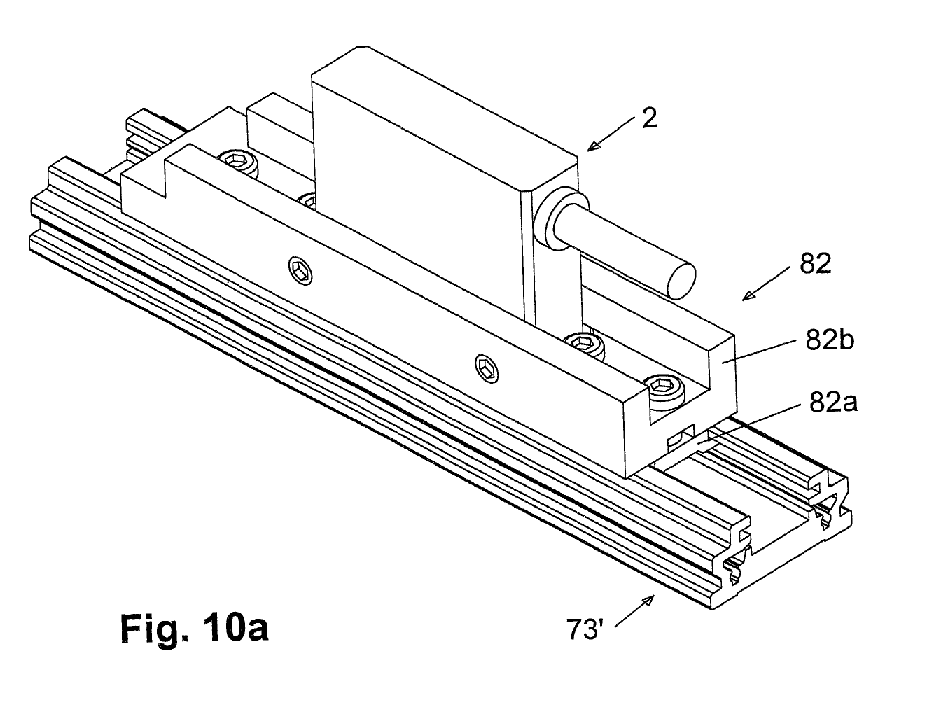

FIG. 10 show a perspective view of another embodiment of the profile bar with slide and sensor head.

As can be seen from FIG. 9, the length measuring device comprises on the one hand the measuring scale 1, the movable sensor 2a and an electronic evaluation system 9 as the sensor 2a, when sliding thereover in the measuring direction 10, detects the segments 27a, 27b which follow each other in succession in that measuring direction 10 and which are magnetised differently and which for example are magnetised alternately as North and South poles and which in particular are of equal length, as an analog sinusoidal signal 28 or in particular as a sine-like analog signal which only comprises positive sine half-oscillations, the electronic system includes on the one hand a converter 9a for converting that periodic analog signal into a periodic digital signal.

The electronic system further includes an interpolator 9b which can also be constructed together with the converter 9a in a structural group and thus as a unitary circuit, and which provides that the periodic digital signal has a higher level of resolution than the underlying periodic analog signal, that is to say the period spacings of the digital signal are shorter in particular by a multiple and in particular by more than the factor 10 and in particular by more than the factor 100 than the period spacings of the analog signal.

In that respect the factor by which the interpolator improves resolution is to be adjustable.

The electronic system further includes an output unit 9c in order to be able to forward the digital signal either to a display unit, for example a digital display 30, as shown in FIG. 2, or to a further processing unit comprising a machine control or a computer 31, as also indicated in FIG. 2.

FIG. 9 further shows that at least the converter 9a and the interpolator 9b of the electronic system are disposed together with the sensor 2a within a structural unit, the sensor unit 2, which is movable in the measuring direction 10 relative to the measuring scale 1.

The output unit 9c is mostly in the form of a plug at the end of a cable leading away from the sensor unit 2.

FIGS. 1 through 8 show structural forms in particular of the head of the sensor unit 2 of the device and in particular the sensor unit 2 thereof in respect of its physical configuration. In that respect the sensor unit 2 is in fact generally arranged on a movable component—not shown in FIGS. 1-6—of a machine, the position of which is to be detected, while the measuring scale 1, on the surface of which the sensor unit 2 is moved in the measuring direction 10, is mounted to a fixed part of the machine.

As the sectional view in FIG. 2 better shows, the measuring scale 1 comprises a magnetic band 1a in which segments 27a, 27b are provided continuously alternately in succession on at least one track 16a in the measuring direction 10, each segment being of the same length but magnetised differently, for example oppositely as North and South poles.

A further track 16b can have a reference mark 32 mostly arranged at only one single longitudinal position on the measuring scale 1, which then in most cases represents the zero position of the system.

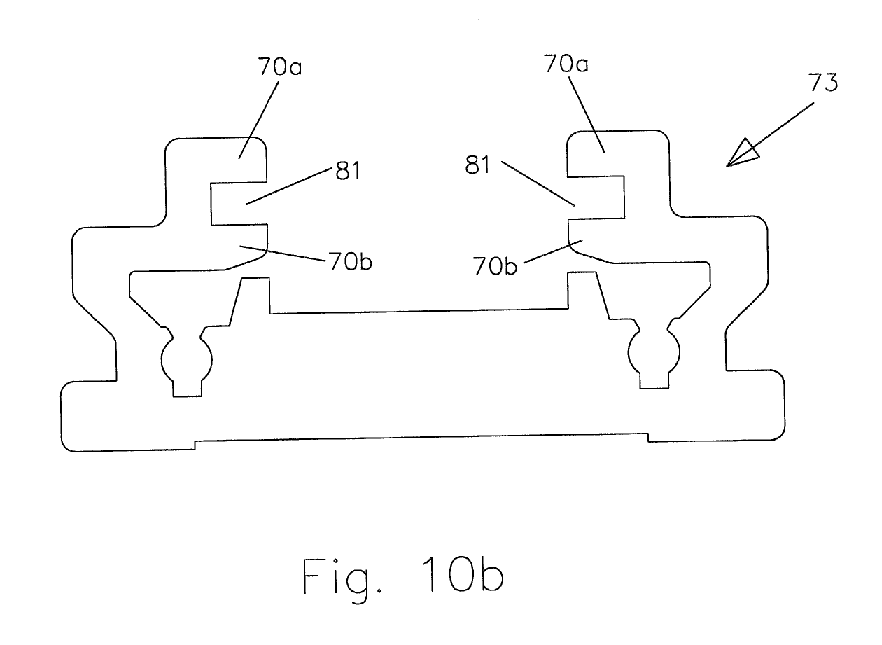

As shown in FIGS. 1-12 that magnetic band 1a can be covered for mechanical protection on the top side thereof by a high-quality steel band 1b or an abrasion-resistant plastic band, and it can be equipped on the underside with an adhesive layer 1c, for mounting to the desired support.

In that case the reference mark 32 does not have to be an integral component part of the magnet band 1a and therewith the rest of the measuring scale 1.

The measuring scale 1 may also include only the continuously alternately magnetised tracks like the track 16a while the reference mark 32 is fixed in place as a separate short portion only at a longitudinal position beside the track 16a, for example also being fixed in place by adhesive, in dependence on the requirements of the respective situation of use.

In that case it is appropriate for that reference mark 32 which must be very accurately positioned to be arranged in correlated relationship with a given longitudinal position of the sensor unit 2 and therewith the machine component fixed to the sensor unit 2. For that purpose it is possible, as shown in FIG. 9, for that separate reference mark 32 to be supported with an abutment 26 which protrudes in the perpendicular 12 to the measuring direction 10 and against which the end face 33 of the sensor unit 2 can abut so that this sensor unit 2 together with the machine part carrying it is moved into the desired position and then the reference mark 32, with the abutment 26 bearing against the sensor unit 2, is fixed in position beside the track 16a of the measuring scale 1.

In all cases it is important that—as shown in FIG. 2—the plurality of sensors 2a, 2b arranged within the sensor unit 2 move at such a spacing relative to each other in the transverse direction 11 corresponding to the tracks 16a, 16b which they are intended to sense.

For that purpose the electronic system 9 arranged within the sensor unit 2 is arranged on one or more circuit boards, preferably on two mutually parallel rigid boards 13a, 13b, and teemed therearound.

In this case the electronic system is disposed either in the interior of a housing (not shown) or the electronic system is teemed after being positioned in a mold 22, as shown in FIG. 2, in which case the mold 22 is then removed again and the encasing for the electronic system consists exclusively of the teeming material 21.

As can be seen from FIGS. 1, 2, 3 and 4 which relate to the same structural configuration, the two boards 13a, 13b which are disposed in parallel relationship extend in the measuring direction 10 and in the perpendicular 12 which projects perpendicularly from the plane of the measuring band which is defined by the measuring direction 10 and the transverse direction 11 extending transversely with respect thereto, at a uniform spacing. In that case the components on the boards 13a, 13b are preferably provided on the mutually facing inward side, which additionally makes it difficult for damage to occur from the exterior.

In that arrangement the boards 13a, 13b extend with their front edges 17a, 17b to close to the front face 34 of the sensor unit 2.

The present design has two sensors 2a, 2b within the sensor unit 2, corresponding to the two tracks 16a, 16b, provided on the measuring scale 1. Those sensors 2a, 2b are respectively arranged on one of the fixed boards 13a, 13b adjacent to or directly at the front edge 17a, 17b thereof, preferably in the longitudinal direction, the measuring direction 10, approximately at the center of those boards 13a, 13b.

With respect to the front face 34 of the sensor unit 2, which faces towards the measuring scale 1, the sensors 2a, 2b are thus only set back so slightly that they are covered by a thin layer of the teeming or casting material 21 as mechanical protection and protection from fouling and contamination.

The two fixed boards 13a and 13b are connected together by way of a flexible board 13′ which projects at the rear edge 19a, 19b of each board 13a, 13b, which edge is remote from the front edge 17a, 17b. That can provide that, before installation in the sensor unit 2, the entire board 13, that is to say comprising the two fixed boards 13a, 13b and the flexible board 13′ which connects them and which has conductor tracks substantially connecting the two fixed boards, can be fitted with components and handled in a developed condition, that is to say when laid out in a plane, as shown in FIG. 4.

So that the integrator b which is also disposed on the boards can also be subsequently adjusted or set in respect of its factor, contact points 16a, 16b . . . of the sensor 2, after manufacture thereof, must still be reachable, in order thereby to be able to re-program by means of suitable programming the interpolator 9b which is generally in the form of a chip 4.

Particularly if the electronic system 9 is teemed with material therearound within a housing of the sensor unit 2 after assembly, one of the boards 3a has a prolongation portion 20 which projects over the rear edge 19a which is otherwise present and extends only over a part of the length of the board 13a, with the contact points 6a, 6b . . . being disposed on the free end thereof. The connecting flexible board 13′ in contrast connects the two boards from the rear edge 19a, 19b . . . which is set back in relation thereto. In that way it is possible, within an existing housing of the sensor unit 2, to cast material around the electronic system 9 thereof by filling with teeming or casting material 21 from the rear face 35 to over the flexible board 13′ and also the rear edges 19a, 19b of the fixed boards 13a, 13b, so that after hardening has occurred only the free end of the prolongation portion 20 and therewith the contact points 6a, 6b thereof project from the teeming material and still remain accessible. The contact points 6a, 6b are then protected by closing the rear 35 of the sensor unit 2 by means of a cover (not shown in greater detail).

In contrast the cable 14 is preferably passed out of one of the end faces 36a, 36b of the sensor unit 2, which face in the measuring direction 10.

In addition FIGS. 3a through 3c show the head of the sensor unit 2 in the finished assembled condition in longitudinal section (FIG. 3a) and in a view from above (FIG. 3b) and as an end view from the side of the cable inlet (FIG. 3c).

FIG. 4 shows the same head with the cover removed, as a plan view, that is to say viewing in the same direction as FIG. 3b.

The body 51a of the housing 51 of the head which is employed in this case is shown separately in three views in FIG. 5. FIG. 5b is a plan view showing the box profile which is closed in itself peripherally and which is open only in the through direction, being the direction of view in FIG. 5b, with its side walls 59a, 59b, in the greater extent, the measuring direction 10, and the side walls which extend transversely with respect thereto.

In this case the box profile of the body 51 is closed at the front face 15 by a front plate 100 which is contoured to correspond to the external periphery of the box profile and which is in the form of a very thin, foil-like metal plate which terminates flush at the external periphery of the box profile and which is peripherally welded to the box profile by a laser beam which is directed thereagainst from the exterior.

With suitable setting of the parameters, that is possible in spite of the greatly different thicknesses of material of the very thin front plate 100 on the one hand and the comparatively thick box profile on the other hand and also the different materials (aluminum and titanium).

Arranged at the inward sides of the internal walls centrally in each case is a respective screw groove 63a, b of a cross-section which is of a circular contour in the central region and thus forms an undercut configuration. The free front opening of the screw groove 63 is approximately of the same width as the board grooves 62a, 62a′ and 62b, 62b′ respectively arranged on both sides beside each screw groove 63a and 63b and which are only slightly spaced from the inside surface of the side walls 59a, b. As FIG. 3 and in particular FIG. 4 show, fixed boards 13a, 13b are inserted in the direction in which the grooves extend into the mutually oppositely disposed pairs 62a, b, 62a′, b, and are guided in positively locking relationship by the grooves and extend upwardly from the front face 15 of the head, which is down in FIG. 3a, to close to the cable sleeve 57 which is inserted in and fixed by means of positively locking engagement in a U-shaped sleeve opening 69 in the one end wall 36 of the body 51a, the opening 69 being U-shaped—see FIG. 5—and open to the rear side of the body 51a which is in opposite relationship to the front face 15.

Passing through the cable sleeve 57 is the cable 14 whose cable sheath ends shortly within the cable sleeve 57 and whose individual wires are electrically connected to the circuitry on the boards 13a, b. Just like the cable 14 and the cable sleeve 57, also disposed in the upper, that is to say rearward, region of the body 51a are through bores 64a, b in the side walls 59a, b of the body 51a, which are preferably arranged symmetrically with respect to the longitudinal center and at an equal spacing relative to the rear of the body 51a. The through bores 64a, b serve for passing through and pressing or screwing transverse sleeve members 65 which thus in spite of the possibility of fitting screws therethrough, for fixing that head, ensure sealing integrity of the internal space of the head with respect to the ambient atmosphere.

As shown in FIG. 3a the boards 13a, b extend essentially only as far as the cable sleeve 57 and thus at a maximum as far as the lower edge of the transverse bores 64a, b, wherein in the case of one board a prolongation portion 20 projects beyond the rear edge 19a, b and extends into the heightwise region of the transverse bores 64a, b, preferably between those transverse bores, as a contracting unit.

The boards 13a, b are electrically connected together by way of a flexible board 13′ from one upper edge 19a, b to the other.

The front edge 17a, b of the boards admittedly extends down to the front face 15 of the body 51a, but on both sides of the center it has bay portions 37 so that it is only in the central region and the side regions that projections 38a), b) reach that front face 15. In that case, arranged on the central projection—like all electronic components on the inward sides of the boards 13a, b, which face towards each other—is a sensor 2a for sensing the measuring scale.

The entire electronic system within the body la is cast around by means of a teeming or casting material 51 which then hardens and thus also securely encloses the front edge 17a, b of the boards 13a, b by virtue of the bay portions 37 thereof. By virtue of the protection for the front edges of the boards 13a, b by the front plate 100 those bay portions 37 are not absolutely necessary and can also be omitted. In the upper region the teeming material extends to beyond the normal rear edge 19a, b of the boards 13a, b and also the connecting flexible board 13′, but leaves free the upwardly projecting free end of the prolongation portion 20 and therewith the contracting unit 6 arranged there.

In FIG. 3, fitted on to the rear side 35 of the body 51a, with which the cable sleeve 57 terminates, is a flat cover 51′b in the form of a plate which is flat on both sides and whose external contour corresponds to the external contour of the body 51a and which is screwed by means of screws 78 through the cover 71′b into the ends, which are open there, of the screw groove 63a, b. After removal of the cover however the contacting unit 6 on the prolongation portion 20 is accessible so that, by fitting a suitable plug or the like on to that contacting unit 6, the electronic system which is already cast in place can be influenced and in particular re-programmed, in a way which is tailored to the respective situation of use of the head.

FIG. 4 shows the head with the cover 51′b removed, in which it is possible to see the transverse sleeve members 65 which pass entirely through the body 51a.

FIG. 3 also shows light emitting diodes 77a, b which are also arranged on one of the boards 13a, b and which are arranged either (77a) near to the front face 15 or near to the cable sleeve 57. In the case of a metal body 51a and cover 51′b, the light from those light emitting diodes can also be seen from the exterior if the teeming material 51 used is translucent and in the case of the diode 77b also the cable sleeve 57. The light from the diode 77a is reflected by the top side of the measuring scale 1 and can also be perceived in use of the head. The one or more light emitting diodes which when using a plurality of light emitting diodes differ in terms of color, serve to display certain operating conditions such as fault-free function, excessively great spacing from the measuring scale, excessively high speed of movement of the head or the like.

FIG. 6 differ from FIG. 3 by virtue of a different cover 51b.

As FIG. 6a shows, the cover 51b is itself a portion of a cover profile 61. It comprises a cover plate 67 which is of an extent in the longitudinal direction, corresponding to the extent of the external dimensions of the body 51a, and two projections 50a, b which protrude towards the same side and which can also form a single continuous projection 50 but are set back from the lateral ends of the cover plate. The cover 51b thus represents a portion of an extrusion, the direction in which it extends being the direction of view in FIG. 6a, that is to say the transverse direction 11 of the head.

Transverse bores 66a, b are already arranged in the profile in the projections 50a, 50b, the transverse bores being aligned in respect of position and in particular also in diameter with the transverse bores 64a, b of the body 51a, so that by means of fitting therethrough for example transverse sleeve members 65 but also screws, it is possible to provide not only for a connection between the cover and the body, but also for fixing of the head to another component.

In order additionally to be able to fix the head from the rear side by means of a screw means which is directed in the perpendicular direction 12, provided at the same time in the projections 50a, b in respective adjacent relationship with the transverse bores 66a, b are fixing screwthreads 68a, b, in the cover 51b, which are in the form of outwardly open blind holes.

FIGS. 7 and 8 show—viewing in the measuring direction 10—a profile bar 73 and the fixing thereof to a support 79 by means of screws 80.

The profile bar 73 serves to receive the measuring scale 1 which—like the sensor unit 2—is shown in FIG. 8, but not shown in FIG. 7 for reasons of simplicity of the drawing. Otherwise the views differ in regard to the nature of the holding clips 74 in FIG. 7 and 74′ in FIG. 8.

At its outer lateral edges the profile bar 73 has an outwardly open groove whose upwardly facing shoulder 72 which in particular extends parallel to the underside of the profile bar 73 comprise the one flank whose outwardly facing shoulder 71 forms the bottom of the groove while the other flank thereof rises inclinedly upwardly. In that arrangement the holding clips 74, 74′ press with their holding limb 74a which extends parallel to the support 79 against the horizontally extending shoulder 72. Because of the symmetry with respect to the longitudinal center, this is preferably effected on mutually opposite sides in each case at the same longitudinal position.

Laterally outside the profile bar 73 the holding clip 74 is screwed against the support 79 by means of a screw 80 which passes through it.

In that case, in the structure shown in FIG. 7, the holding clip 74 is of a substantially C-shaped configuration continuously from the left to the right side of the profile bar 73 so that a screw 80 passes through the holding clip 74 doubly on each side, through the limbs which are in parallel relationship with each other. In that way the profile bar 73 bears against the inside of the continuous limb of the C-shaped holding clip 74.

In contrast, in the structure shown in FIG. 8, the holding clips 74′ are each arranged individually at each side and are also of a C-shaped configuration, but the holding limb 74a projects further in the direction of the profile bar 73, where it can engage into the outer groove there, than the other counterpart limb which ends freely and which is disposed above the holding limb 74a. In this case also each clip 74′ is respectively screwed by the screws 80 through the two limbs so that tightening of the screw 80 in this case also causes compression of the limbs and thus causes the profile bar 73 to be urged downwardly.

The profile bar 73 is of a substantially also C-shaped upwardly open configuration with a centrally arranged, upwardly facing base surface 55 for attachment of the measuring scale 1 whose magnet band 1a is glued by means of an adhesive strip 1b on the base surface 55. Laterally beside the base surface and beside the measuring scale 1, raised portions 56 project upwardly to such an extent that the top side of the measuring scale 1 when mounted on the profile bar 73 is set back somewhat in relation thereto.

The freely ending limbs of the C-shape project above the upper ends of the raised portions 56 substantially parallel to the support 79 towards the center, but still outside the raised portions 56, and, with their freely ending projections 70, form the lateral guide means for a measuring head 2 which does not enjoy precise lateral guidance by means of the component carrying it.

Arranged between the raised portions 56 and therewith the base surface 55 and the projections 70 which project higher, on each side of the profile bar 73, is a respective undercut groove 75 with a substantially round central cross-sectional region, as described with reference to the screw grooves 63a, b of the body 51. They serve for screwing on a closure cover at the end or also for inserting fitting pins 76 into the enlarged groove of an undercut configuration, in the end direction, in order to be able to attach a plurality of elements of a profile bar 73 in aligned relationship at their ends in succession.

The underside of the profile bar 73 is preferably set back somewhat in the central region with respect to the edges so that the profile bar 73 only fits with its edge regions on the support or on the holding clips 74 which extend therebeneath.

FIG. 10a shows a perspective view of a further configuration 73′ of the profile bar, with a slide 82 which is guided thereon and to which the head of the sensor unit 2 is fixed, in particular screwed.

FIG. 10b shows the profile bar 73′ of FIG. 10a alone and viewed in the longitudinal direction of the profile bar 73′.

As can best be seen from FIG. 10b, this form of the profile bar 73′ differs from that shown in FIGS. 7 and 8 in that, in the case shown in FIG. 10b, the projections 70 are in the form of forked projections 70a, 70b which form between them a respective guide groove 81 which is open towards the longitudinal central plane of the profile bar 73′ and which in particular is of a rectangular shape so that a suitably dimensioned plate which is disposed horizontally, that is to say parallel to the bottom of the profile bar 73′, can be inserted in the longitudinal direction into the profile bar 73′.

Instead of a plate, in that case, a U-shaped profile is used as the lower part 82a of a slide 82, as is best seen from FIG. 10a.

Screwed to that lower part 82a is an upper part 82b, on which the head of the sensor unit 2 is fixed.

In this case—viewed in the longitudinal direction of the profile bar—the upper part 82b is of a U-shaped configuration and the head of the sensor unit 2 is screwed in place in the upwardly open internal free space of that U-shape.

That upper part 82b is guided by the lower part 82a just above the upper end of the projections 70 and projects laterally somewhat beyond them.

In addition the arrangement may have a cover band 83 in the form of a flat material for protecting the magnet band la which in the direction of the width of the profile bar 73 extends over the entire base surface 55 and the magnet band 1a fitted therein as well as the raised portions 56 which stand up laterally therebeside, to a position below the inwardly cranked projections 70 of the profile.

The cover band 83 can thus be inserted in positively locking relationship in the longitudinal direction of the profile bar 73 and only has to comprise a non-magnetisable material, for example high-quality steel, or a plastic material, for example PEEK.

In addition the grooves 75 for insertion of the fitting pins 76 can be disposed, in relation to the above-described alternative configurations, further at the center of the profile bar 73, namely under the base surface 55.

List of References

1 measuring scale

2 sensor unit

2a sensor

4 first chip

5 second chip

6 contacting unit

6a, 6b contact points

7 programming unit

8 third chip

9a converter

9b interpolator

9c output unit

10 measuring direction

11 transverse direction

12 perpendicular to the measuring scale plane

13a, 13b board

13′ flexible board

14 cable

15 front face of the sensor unit

16 tracks

17a, 17b front edge

19a, 19b rear edge

20 prolongation portion

21 teeming material

22 mold

23 support means

24 contact openings

25 light emitting diode

26 abutment

27a, 27b segments

28 signal

29a, 29b rectangular signal

30 digital display

31 computer

32 reference mark

33 end face

34 front face

35 rear

36a, 36b end face

37 bay portions

38a, 38b projection

40a, 40b bores

50 projection

51 housing

51a body

51b cover

52 length

53 width

54 height

55 base surface

56 raised portion

57 cable sleeve

58 transverse bore

59a, 59b side walls

60 body profile

61 cover profile

62a, 62b board groove

63a, 63b screw grooves

64a, 64b transverse bore

65 transverse sleeve member

66a, 66b transverse bore

67 cover plate

68a, 68b fixing screwthread

69 sleeve opening

70 projections

70a, b forked ends

71 shoulder

72 shoulder

73 profile bar

74 holding clip

74a holding limb

75 groove

76 fitting pin

77a, 77b light emitting diode

78 screw

79 support

80 screws

81 guide groove

82 slide

82a lower part

82b upper part

83 cover band

100 front plate

1. A length measuring device comprising
a measuring scale (1) which is coded alternately in the measuring direction (10), and
a sensor unit (2) which is movable in the measuring direction (10) relative to the measuring scale (1) and in the sensor head includes at least one sensor (2a) for contact-lessly detecting the magnetically modulated signals of the measuring scale (1), as well as an electronic means (9) arranged on at least one circuit board (13a),
characterised in that the head of the sensor unit (2) includes a housing (51) with a housing body (51a) and the housing body (51a) is of a uniform cross-section in at least one direction at least in a region-wise manner.

2. A length measuring device as set forth in claim 1 characterised in that
the housing body (51a) of the head is sealingly closed at its measuring side by a front plate (100) and in particular the front plate (100) lies flush on the front end face of the rest of the body (51a) and is in particular glued or welded thereto, and in particular
the front plate (1) comprises non-magnetic metal, in particular titanium or aluminum, and in particular
the front plate (100), in the case of a magnetoresistive sensor, is of a thickness of between 10 and 500 μm, in particular between 10 and 50 μm.

3. A length measuring device as set forth in one of the preceding claims characterised in that
the front plate (100) is arc welded or laser welded or ultrasound welded to the remainder of the body (51a), and in particular
the materials of the front plate (100) and the rest of the body (51a) are identical, and in particular
the materials of the front plate (100) and the rest of the body (51a) are different but are alloyable with each other and in particular are weldable to each other, and in particular the body (51a) comprises aluminum and the front plate comprises titanium.

4. A length measuring device as set forth in one of the preceding claims characterised in that
in the direction (12) perpendicular to the plane of the measuring scale (1), the housing body (51a) is of a uniform cross-section, and in particular
the housing body (51a) is of a uniform cross-section over its entire extent, in particular its entire height (12), and/or in particular
the housing body (51a) and in particular the entire housing (51) comprises metal, in particular aluminum, and in particular
the housing (51) is a housing with an open front face (15), which is produced by a drawing process or a pressing process.

6. A length measuring device as set forth in one of the preceding claims characterised in that
the housing body (51a) is a portion of a body profile (60), produced in particular by extrusion or continuous casting, with an in particular open front face (15) and a rear (35) closable by a cover (51b), or in particular comprises two half-shell portions which in particular are also produced by extrusion or continuous casting, and/or in particular
the cover (51b) is a portion of a second cover profile (61), and in particular
the cover (51b) is formed hingedly with a cable sleeve (57), in particular in one piece with the cable sleeve (57) which serves for passing the cable (8) through the wall of the housing (51).

7. A length measuring device as set forth in one of the preceding claims characterised in that
the body profile (60) of the housing body (51a) is symmetrical with respect to the longitudinal direction, the measuring direction (10), and/or symmetrical with respect to the transverse direction (11), and/or in particular
the body profile (60) has, symmetrically relative to each other with respect to the center extending in the transverse direction (11), at least one pair of mutually opposite board grooves (62a, b) on the inward sides of the end walls (33a, b), for insertion of a board in the direction in which the board grooves (62a, b) extend, in particular in the perpendicular direction (12), and/or in particular
the body profile (60), on the inside of the end walls (33a, b), in mutually opposite relationship with respect to the center extending in the transverse direction (11), has at least one pair of undercut screw grooves (63a, b), and in particular
the screw grooves are of a very small free cross-section which is larger than the thickness of the fixed boards (13a, b) and in particular corresponds to the width of the board grooves (62a, b), and in particular
the cover (51b) is a flat plate with a base area corresponding to the external contour of the body profile (60), lies on the flat rear (35) of the body profile (60) and in particular is screwed by way of through openings by the screws engaging into the screw grooves (63a, b).

8. A length measuring device as set forth in one of the preceding claims characterised in that
provided in the side walls (59a, b) of the body (51a) near the rear (35) thereof are at least one pair of mutually aligned transverse bores (64a, b), preferably two pairs (64a, 64b, 84′a, 64′b) of transverse bores, for fixing the sensor unit (2) to another component, and/or in particular
arranged in each pair of transverse bores (64a, 64b, 64′a, 64′b) is a transverse sleeve member (65) which penetrates through the body (51a) and which is clamped or glued in the side walls (59a, 59b).

9. A length measuring device as set forth in one of the preceding claims characterised in that
the cover (51b) comprises a portion of a cover profile (61) extending transversely with respect to the direction in which the body profile (60) extends and in particular has at least one pair of transverse bores (66a, 66b) which after positioning of the cover are aligned with the transverse bores (64a, 64b) of the body (51a) and serve in particular for screwing the cover (51b) to the body (51a), and in particular
a cover (51b) projects in between the side walls (59a, 59b) and for that purpose the end walls (33a, 33b) of the body (51a) are removed corresponding to the thickness of the cover (51b) at the rear (35), and/or in particular
a cover (51b) has at least one fixing screwthread (68a) which in particular is in the form of a blind bore open to the outside of the housing (51) and extends in particular in the longitudinal direction of the body profile (60), and in particular
a cover (51b) in the region of the fixing screwthread (68a . . . ) is of a thickness corresponding at least to the diameter of the transverse bores (66a, 66b) and a fixing screwthread (68a, 68b) is arranged preferably displaced in the longitudinal direction, the measuring direction (10), beside each of the transverse bores (66a, 66b).

10. A length measuring device as set forth in one of the preceding claims characterised in that
an electronic circuit is arranged on two fixed circuit boards (13a, 13b) which are connected together by way of a flexible circuit board (13′) and a respective one of the fixed boards (13a, 13b) is disposed in a pair of board grooves (62a, 62b) and the connecting flexible circuit board (31′) connects the two fixed circuit boards (31a, 31b) on the rearward edge thereof, and in particular
one of the two fixed circuit boards (13a, 13b) has a prolongation portion (20), projecting beyond the rear edge (19), with electrical contact points (6a, 6b . . . ) of a contacting unit (6), and the prolongation portion (20) is arranged in a region in the measuring direction (10), in which there are no transverse bores (64a, 64b) in the body (51a) of the housing (51), and in particular
a third board is inserted into the screw grooves (63a, 63b) and is connected in particular to the other two fixed boards (34a, 34b) by way of electrically conductive connections, in particular respective flexible boards (31′, 31″), and the rear edge of said board terminates so far in front of the rear (35) of the body (51a) that screws for fixing the cover can still be screwed into the screw grooves (63a, 63b) from the rear.

11. A length measuring device comprising
a measuring scale (1) which is coded alternately in the measuring direction (10), and
a sensor unit (2) which is movable in the measuring direction (10) relative to the measuring scale (1) and in the sensor head includes at least one sensor (2a) for contact-lessly detecting the magnetically modulated signals of the measuring scale (1), as well as an electronic means (9) arranged on at least one circuit board (13a),
characterised in that
the sensor (2a) is also arranged on a board (13a), and/or in particular
the at least one sensor (2a) is arranged in the form of a bare, non-housed circuit, in particular a chip (8a), on the board (13a), and/or in particular
further components of the electronic system (9), in particular the converter (9a) thereof and/or the interpolator (9b) thereof or both are arranged as a bare non-housed circuit, in particular a chip (4, 5), on one of the boards (13a, 13b).

12. A length measuring device comprising
a measuring scale (1) which is coded alternately in the measuring direction (10), and
a sensor unit (2) which is movable in the measuring direction (10) relative to the measuring scale (1) and in the sensor head includes at least one sensor (2a) for contact-lessly detecting the magnetically modulated signals of the measuring scale (1), as well as an electronic means (9) arranged on at least one circuit board (13a),
characterised in that
the electronic system (9) is cast in an at least partially hardening teeming material (21) whose shrinkage upon hardening is so slight that the electronic system is not damaged upon hardening, in particular epoxy resin which contains in particular between 10% and 75% of filler, for example powdered quartz, and in particular
at least the active electronic components of the electronic system (9) such as circuits, in particular chips (8a, 8b, 4, 5), are encased completely by the teeming material, except the cross-sections whose electrical contacts go to the board (13a, 13b), and in particular
the external surfaces of the teeming material (21) which keeps its shape and which encloses the electronic system are at the same time the external surfaces of the sensor unit (2).

13. A length measuring device comprising
a measuring scale (1) which is coded alternately in the measuring direction (10), and
a sensor unit (2) which is movable in the measuring direction (10) relative to the measuring scale (1) and in the sensor head includes at least one sensor (2a) for contact-lessly detecting the magnetically modulated signals of the measuring scale (1), as well as an electronic means (9) arranged on at least one circuit board (13a),
characterised in that
the width (51) of the head of the sensor unit (2) is at a maximum twice the width of the measuring scale (1), in particular no wider than the measuring scale (1), preferably less wide than the measuring scale (1), and in particular
the extent of the head in the measuring direction (10) is no greater than 70 times and in particular 50 times the extent of a segment (27a, 27b) of the measuring scale (1), and/or in particular
the rear side (35) of the head of the sensor unit (2) is flat and/or the side walls (33a, 33b) of the head of the sensor unit are externally flat.

14. A process for producing the sensor unit (2) of a length measuring device comprising the following steps:
electrically conductively connecting the wires of the cable (8) to the contact points (39a, 39b, 39c) of the circuit on the at least one circuit board (13a),
inserting the at least one board (13a, 13b) in the direction in which the grooves extend in the interior of the body profile (60), in particular the board grooves (62a, 62b),
inserting the cable sleeve (57) with cable (8) passing therethrough from the rear (35) of the body (51a) into the sleeve opening (39),
sealingly pressing the body (51a) with the flat front face (15) on to a flat sealing support,
filling the interior of the body (51a), leaving free above the rest of the rear edge (19a . . . ) of the at least one board (13a, 13b) the contact points (6a, 6b . . . ) of the contacting unit (6) which project rearwardly beyond the rear edge (19a),
after hardening lifting the body (51a) off the sealing support,
electrically conducting connecting the contacting unit (6) to a programming unit for programming at least the interpolator (9b) of the electronic system (9) of the sensor unit (2),
after removal of the contacting unit fitting the cover (51b) to the rear (35) of the body (51a) of the sensor unit (2) and fixing it to protect the subjacent contacting unit (6), and/or in particular
before insertion of the boards (13a, 13b) into the body (51a) it is shortened to the desired dimension in respect of its extent in the perpendicular (12), in particular in the direction in which the body profile (60) extends, the shortening being effected in particular at the front face (15), and/or in particular
a plurality of fixed boards (13a, 13b) are connected together by way of a flexible board (13) and prior to insertion into the inner grooves of the body (51a) folded into a mutually parallel position corresponding to the spacing of the pairs of grooves, in particular the board grooves (62a, 62b, 62′a, 62′b) and/or the screw grooves (63a, 63b), and inserted jointly, in particular with the bent flexible board (13′) leading, and/or in particular
after removal of the programming unit and before fitment of the cover (51b) further casting is also effected around the contact points (6a, 6b) of the contacting unit (6), and/or in particular
insertion of the at least one board (13) into the grooves and the cable sleeve (5) with cable (8) into the opening (69) is effected jointly from the rear side (35).

15. A length measuring device comprising
a measuring scale (1) which is coded alternately in the measuring direction (10), and
a sensor unit (2) which is movable in the measuring direction (10) relative to the measuring scale (1) and in the sensor head includes at least one sensor (2a) for contact-lessly detecting the magnetically modulated signals of the measuring scale (1), as well as an electronic means (9) arranged on at least one circuit board (13a),
characterised in that
the measuring scale (1) is glued on the support by means of a thick compensating adhesive layer, in particular of a thickness of between 0.1 mm and 1.0 mm, and in particular
the measuring scale (1) is stuck on an inherently stable profile bar (73), in particular in the form of an extrusion profile, on a base surface (55) there, the width of which is no or only slightly (wider) than the width of the measuring scale (1), and in particular
provided on at least one side, in particular on both sides, of the base surface (55), is a raised portion (56) whose height is greater than the thickness of the measuring scale (1) including adhesive layer, and in particular
the profile bar (73) is of a symmetrical configuration relative to the longitudinal center.

16. A length measuring device as set forth in one of the preceding claims characterised in that
provided above the upper end of the raised portions (56) on both sides is a respective projection (70) facing radially from the outside towards the longitudinal center and ending outside the raised portions (56), for lateral guidance of the head of a sensor unit (2), and in particular
provided between the raised portions (56) and the projections (70) is a respective upwardly open, in particular undercut groove which is in particular lower than the base surface (55), and/or in particular
the profile bar (73) at its lateral outer end, in particular outside the projections (70), has an upwardly facing shoulder (71) and in particular opposite thereto in upwardly projecting and outwardly facing relationship shoulders (72) for fitting the holding limbs (74a) of holding clips (74), and in particular
the holding clips (74) at the transition of two profile bars (73) which are in mutually adjoining relationship at the ends serve for aligned orientation of the two profile bars relative to each other.

17. A length measuring device as set forth in one of the preceding claims characterised in that when two profile bars (73) adjoin each other at the ends, fitted into the upwardly open grooves (75) are fitting pins (76) which fit with their mutually opposite ends into the two mutually adjoining profile bars (73).

18. A length measuring device as set forth in one of the preceding claims characterised in that
the projections (70) are of a forked configuration and between their forked ends have a guide groove (81) for guiding a slide (82), and/or in particular
an in particular undercut guide groove (81′) is provided between the raised portion (56) and the projection (70) on each side of the profile bar (73), and/or in particular
the slide (82) comprises an interconnected, in particular screwed lower part (82a) and an upper part (82b), wherein the lower part (82a) is guided in the guide groove (81, 81′) in positively locking relationship and displaceably only in the longitudinal direction of the profile bar (73), and in particular
the upper part (82b) is held at a small spacing above the upper ends of the projections (70) by means of the lower part (82a) and in particular projects laterally beyond the projections (70).
